(19) United States
(12) Patent Application Publication
(10) Pub. No.: US 2008/0289506 A1
(43) Pub. Date: Nov. 27, 2008

(54) PORTABLE WELDING SMOG DISPOSING MACHINE

(76) Inventor: Chieh-Yuan Cheng, Taichung (TW)

Correspondence Address: SINORICA, LLC, 528 FALLSGROVE DRIVE, ROCKVILLE, MD, 20850, US

(21) Appl. No.: 11/751,897

(22) Filed: May 22, 2007

(51) Int. Cl. B01D 29/05

(52) U.S. Cl. 96/147

(57) ABSTRACT

A portable welding smog disposing machine includes a machine box formed with an accommodating space disposed at an intermediate portion with a filter plate set, which partitions the accommodating space into a front and a rear accommodating chamber. The front accommodating chamber has its topside bored with a through hole extending upward and its front side formed with an opening having a door plank pivotally assembled thereon. An ember obstruction device is fixed on the inner side of the door plank and received inside the front accommodating chamber. By so designing, the embers produced during electric welding will be pumped to directly drop into the ember obstruction device through the through hole to be collected therein so as to prevent the embers from getting into the machine box.

### BACKGROUND OF THE INVENTION

1. Field of the Invention

This invention relates to a portable welding smog-disposing machine, particularly to one able to effectively dispose the smog and the embers produced during carrying out electric welding work.

2. Description of the Prior Art

As commonly known, when a metal welding factory carries out metal welding work, such as argon welding, electric welding and thermal treatment, a great quantity of welding smog containing heavy metals like lead, manganese and nickel will be produced. Under the circumstances, the operator who works in a working environment full of welding smog is likely to inhale too much heavy metals in the welding smog, thus not only polluting the working environment but endangering the operator's health as well. For the present, many factories can hardly achieve good effect in ventilation on account of nearby buildings. Although an operator wearing a breathing protector can avoid inhaling too much heavy metals in the welding smog, yet wearing the breathing protector to carry out welding work is likely to affect the quality of electric welding work, and the welding smog will still influence other people who do not wear breathing protector and pollute the environment around. To solve the problems mentioned above, such a factory is usually installed with industrial filtration equipment for carrying out air filtration, and such filtration equipment is provided with one or more filter nets for filtrating air. However, in the course of electric welding, lots of oily dirt and impurities will be produced and, as a consequence, the filter nets are easily clogged with such oily dirty and impurities; therefore, the filter nets have to be timely washed clean or replaced with new ones to maintain good quality of the air in the working environment. In addition, most of the industrial filtration equipment is provided with no device for obstructing the embers produced during electric welding; therefore, the embers will be sucked into the interior of the equipment and may cause a fire or air explosion.

### SUMMARY OF THE INVENTION

The objective of the invention is to offer a portable welding smog-disposing machine including a machine box formed with an accommodating space in the interior. The accommodating space is provided with a filter plate set at an intermediate portion, which partitions the accommodating space into a front accommodating chamber and a rear accommodating chamber. The front accommodating chamber has its front side formed with an opening pivotally assembled thereon with a door plank by means of the fasteners secured on the opposite sides of the machine box at the location adjacent to the opening. An ember obstruction device is fixed on the inner side of the door plank and received in the interior of the front accommodating chamber, composed of a shade formed with an upper opening and a lower opening communicating with each other, and a horizontal groove provided under the shade and communicating with the lower opening of the shade, with the upper opening of the shade communicating with the through hole at the topside of the front accommodating chamber.

Thus, the embers produced during electric welding will be sucked to directly drop into the ember obstruction device through the through hole of the front accommodating chamber to be collected therein for preventing the embers from getting into the machine box and potentially causing a fire or gas explosion. In addition, the door plank can be conveniently disassembled from the machine box for facilitating pouring out the embers and washing clean the ember obstruction device. Moreover, the filthy air produced by the embers will be filtrated repeatedly by the filter plate set in the accommodating space; therefore, the air exhausted out of the machine box is unpolluted, able to effectively maintain good quality of the air in the working environment.

### BRIEF DESCRIPTION OF DRAWINGS

This invention will be better understood by referring to the accompanying drawings, wherein:

FIG. 1 is a perspective view of a portable welding smog-disposing machine in the present invention;

FIG. 2 is a partial exploded perspective view of the portable welding smog disposing machine in the present invention; and

FIG. 3 is a side cross-sectional view of the portable welding smog-disposing machine in an operating condition in the present invention.

### DETAILED DESCRIPTION OF THE PREFERRED EMBODIMENT

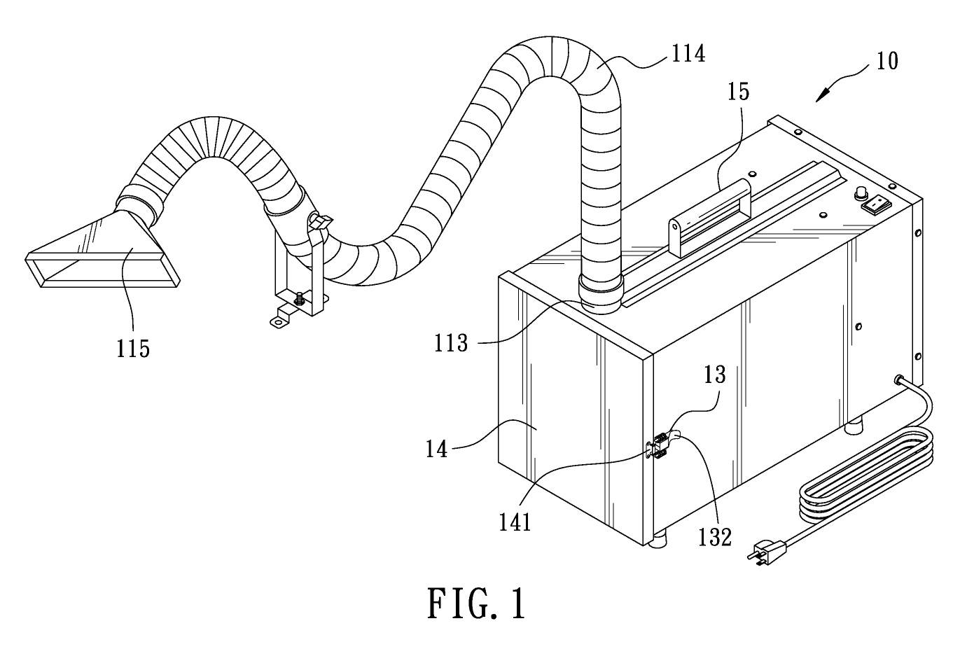

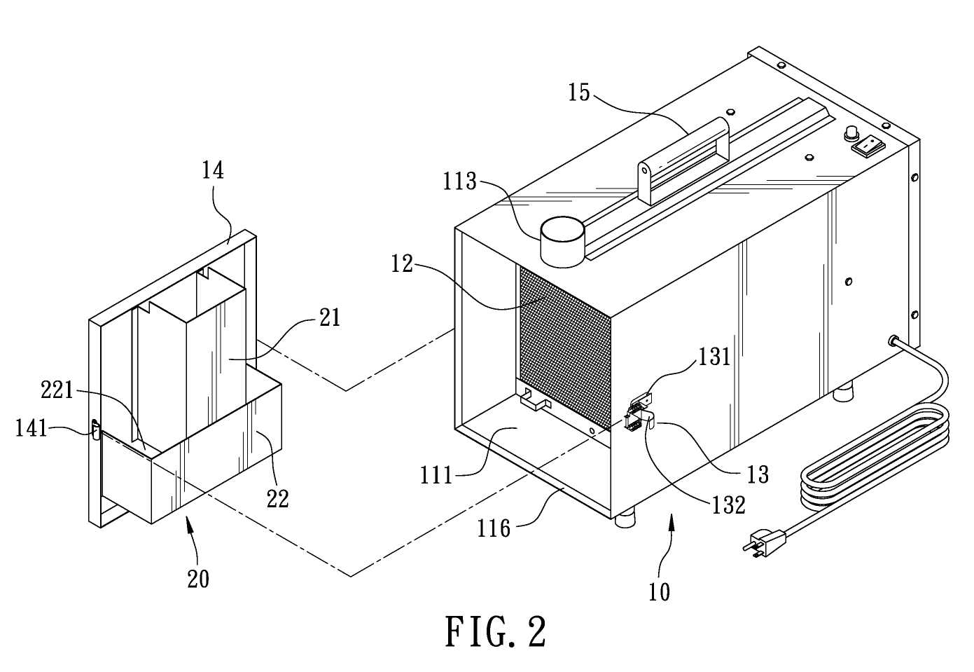

A preferred embodiment of a portable welding smog-disposing machine in the present invention, as shown in FIGS. 1, 2 and 3, includes a machine box 10, an ember obstruction device 20 and plural blowers 30 preset in number.

The machine box 10 is formed in the interior with an accommodating space 11 having an intermediate preset portion disposed with a filter plate set 12, which partitions the accommodating space 11 into a front accommodating chamber 111 and a rear accommodating chamber 112. The front accommodating chamber 111 has its topside bored with a through hole 112 extending upward and fitted thereon with an air pumping pipe 114 that is contractible and flexible to be bent freely. The air-pumping pipe 114 has its outer end connected with a funnel-shaped pumping pipe head 115 for facilitating sucking embers. The front accommodating chamber 111 has its front side formed with an opening 116, and the machine box 10 has its opposite sides respectively fixed thereon with a fastener 13 at a location corresponding to the front accommodating chamber 111, and the two fasteners 13 respectively consist of a clasping base 131 and a clasping member 132 fixed on the clasping base 131. The opening 116 at the front side of the front accommodating chamber 111 is pivotally assembled thereon with a door plank 14 having its opposite edges respectively fixed with a clasping ring 141 for the clasping member 132 of the clasping base 131 to be clasped thereon. Thus, the machine box 10 can be closed or opened by pulling open the clasping member 132 at either side of the machine box 10, and the door plank 14 can be disassembled from the machine box 10 by pulling open the two clasping members 132 at the opposite sides of the machine box 10. Further, the machine box 10 is disposed with a handle 15 at the central portion of its topside for facilitating moving the machine box 10.

The ember obstruction device 20 shaped as an inverted T is secured on the inner side of the door plank 14 and received in the interior of the front accommodating chamber 111. The ember obstruction device 20 is composed of a shade 21 formed with an upper opening and a lower opening communicating with each other, and a horizontal groove 22 provided under the shade 21 and communicating with the lower opening of the shade 21. A space formed between the lower end of the shade 21 and the bottom of the groove 22, and two upward openings 221 are respectively formed at the opposite sides of the groove 22 and communicating with both the interiors of the shade 21 and of the groove 22. By so designing, the embers sucked to get into the ember obstruction device 20 can directly drop into the groove 22.

The blowers 30 are firmly assembled inside the rear accommodating chamber 112 so that the air, after filtrated by the filter plate set 12, can be pumped by the blowers 30 and exhausted out of the machine box 10 through numerous air exhaust holes 117 bored in the lower wall of the rear accommodating chamber 112.

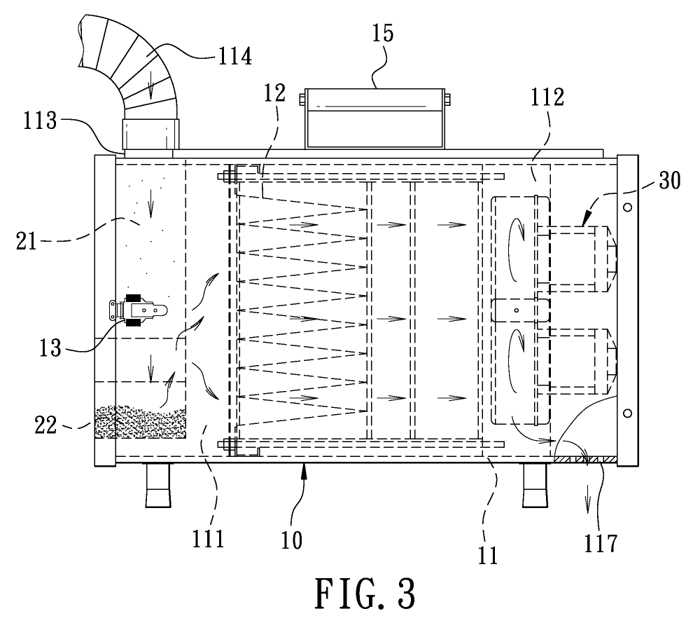

In using, referring to FIG. 3, the portable welding smog disposing machine is first placed at a proper location, letting the pumping pipe head 115 properly aligned to the electric welding site. Thus, when the blowers 30 are started to rotate, the embers produced by electric welding can be sucked into the shade 21 of the ember obstruction device 20 through the pumping pipe head 115 and the air pumping pipe 114 as well as through the through hole 113 and then directly drop into the groove 22 under the shade 21. Simultaneously, the filthy air produced by the embers will be exhausted to get into the accommodating space 11 of the machine box 10 through the two openings 221 at the opposite upper sides of the groove 22 to be filtrated repeatedly by the filter plate set 12 in the accommodating space 11, letting the air become nearly unpolluted. Meanwhile, this unpolluted air will be pumped by the blowers 30 in the rear accommodating chamber 112 and exhausted out of machine box 10 through the air exhaust holes 117 in the lower wall of the rear accommodating chamber 112, able to effectively maintain good air quality in the working environment.

After the ember obstruction device 20 has been used for a period of time and the groove 22 is filled up with embers, simply pull open the clasping members 132 that are clasped on the clasped rings 141 at the opposite edges of the door plank 14 to disassembled the door plank 14 from the machine box 10 for pouring out the embers and wash clean the ember obstruction device 20.

As can be understood from the above description, this invention has the following advantages.

1. The embers produced during electric welding can be pumped to directly drop into the ember obstruction device to be collected therein, able to prevent the embers from getting into the machine box and possibly causing a fire or air explosion. Further, the filthy air produced by the embers will be filtrated repeatedly by the filter plate set so the sir exhausted out of the machine box is unpolluted, able to effectively maintain good quality of air in the working environment.

2. The door plank clasped on the front opening of the machine box by means of the fasteners secured at the opposite sides of the machine box can easily be disassembled from the machine box for facilitating pouring out the embers and washing clean the ember obstruction device.

3. The machine box is provided with a handle at the central topside for facilitating moving of the machine box, and the welding smog-disposing machine of this invention is light and convenient to be carried about.

4. The portable welding smog disposing machine of this invention is applicable to metal welding work, such as argon welding, electric welding and thermal treatment, and also can be used to carry out air filtration for various sorts of factories.

While the preferred embodiment of the invention has been described above, it will be recognized and understood that various modifications will be made therein and the appended claims are intended to cover all such modifications that may fall within the spirit and the scope on the invention.

I claim:

1. A portable welding smog disposing machine comprising:
a machine box formed with an accommodating space in its interior, said accommodating space disposed with a filter plate set at an intermediate preset portion, said filter plate set partitioning said accommodating space into a front accommodating chamber and a rear accommodating chamber, said front accommodating chamber having its front side formed with an opening, said opening pivotally assembled thereon with a door plank for closing or opening said machine box, said front accommodating chamber having its topside bored with a through hole extending upward;
an ember obstruction device shaped as an inverted T, said ember obstruction device secured on an inner side of said door plank and received in an interior of said front accommodating chamber, said ember obstruction device composed of a shade and a horizontal groove, said shade formed with an upper and a lower opening communicating with each other, said horizontal groove provided under said shade and communicating with said lower opening of said shade, said shade having its upper opening communicating with said through hole at a topside of said front accommodating chamber; and
at least one blower installed in an interior of said rear accommodating chamber, filthy air produced by embers, after filtrated by said filter plate set, pumped by said blowers and exhausted out of said machine box through air exhaust holes bored at a lower wall of said rear accommodating chamber.

2. The portable welding smog-disposing machine as claimed in claim 1, wherein a space is formed between a lower end of said shade and a bottom of said groove.

3. The portable welding smog-disposing machine as claimed in claim 1, wherein a contractible air-pumping pipe is fitted on said through hole at the topside of said front accommodating chamber.

4. The portable welding smog disposing machine as claimed in claim 3, wherein said air pumping pipe has its outer end connected with a funnel-shaped pumping pipe head.

5. The portable welding smog disposing machine as claimed in claim 1, wherein said machine box is provided with a handle protruding upward in a center of its topside.

6. The portable welding smog disposing machine as claimed in claim 1, wherein said machine box has its opposite sides respectively secured with a fastener at a location adjacent to said opening, said fastener composed of a clasp base and clasp member, said door plank having its opposite edges respectively fixed with a clasping ring at a location corresponding to said fastener of said machine box, said fastener clasped with said clasping ring of said door plank.
